(19) United States
(12) Patent Application Publication
(10) Pub. No.: US 2020/0117162 A1
(43) Pub. Date: Apr. 16, 2020

(54) NUMERICAL CONTROL DEVICE

(71) Applicant: FANUC CORPORATION, Yamanashi (JP)

(72) Inventor: Takayuki KOYAMA, Yamanashi (JP)

(73) Assignee: FANUC CORPORATION, Yamanashi (JP)

(21) Appl. No.: 16/600,257

(22) Filed: Oct. 11, 2019

(30) Foreign Application Priority Data
Oct. 15, 2018 (JP) 2018-194418

(51) Int. Cl. G05B 19/18

(52) U.S. Cl. CPC G05B 19/182; G05B 2219/45044

(57) ABSTRACT

To provide a numerical control device that cause a cutting device, etc., to execute cutting without oscillation in a case of determining as being a surface quality-prioritized machining determination unit. An oscillation component creating unit creates an oscillation component command for oscillation cutting, and to command a servo motor. An oscillation component creating determination unit determines an oscillation cutting block in a machining program, and to instruct an oscillation component creating unit to perform creation of an oscillation component command. A surface quality-prioritized machining determination unit determines a surface quality-prioritized machining part in the oscillation cutting block. In a case of determining as being a surface quality-prioritized machining part, the surface quality-prioritized machining determination unit instructs the oscillation component creating determination unit to stop oscillation component creation, and the oscillation component creating determination unit that is instructed to stop the oscillation component creating instructs the oscillation component creating unit to stop creation an oscillation component command.

This application is based on and claims the benefit of priority from Japanese Patent Application No. 2018-194418, filed on 15 Oct. 2018, the content of which is incorporated herein by reference.

### BACKGROUND OF THE INVENTION

### Field of the Invention

The present invention relates to a numerical control device applied to a machine tool such as a cutting device.

### Related Art

Conventionally, in a case of performing cutting in a machine tool, there is a function to machine while oscillating the cutting tool in order to mince chips. For example, a numerical control device having such a function has been proposed (for example, refer to Japanese Unexamined Patent Application, Publication No. 2017-56515 and PCT International Publication No. WO2017/051742). With these technologies, since the cutting tool oscillates, there is an advantage in that it is possible to mince such chips efficiently. FIG. 7 is a diagram illustrating a state of cutting with oscillation. As illustrated in FIG. 7, for example, a workpiece 1 rotates in the rotational direction A around a rotational axis 2, and a tool 2 moves on the surface of the workpiece 1, thereby performing cutting. The tool 3 moves in a machining direction D, and while cutting is performed, oscillation cutting B having oscillation in the cutting is performed. Therefore, a trajectory on the surface of the workpiece 1 becomes a trajectory which oscillates due to the oscillation, as indicated by a tool movement trajectory C (refer to FIG. 7).

Patent Document 1: Japanese Unexamined Patent Application, Publication. No. 2017-56515

Patent Document 2: PCT International Publication No. WO2017/051742

### SUMMARY OF THE INVENTION

In the oscillation for mincing the chips, acceleration frequently changes, as compared with other types of machining. Therefore, there is an issue in that the surface quality of a machined workpiece surface deteriorates.

In the technology disclosed in Japanese Unexamined Patent Application, Publication No. 2017-56515, a shredding condition that can mince the chips is created on the basis of a machining condition for actual cutting. To realize this, in the technology disclosed in Japanese Unexamined Patent Application, Publication No. 2017-56515, learning control based on a rotation speed and the oscillation frequency of an oscillation command is executed. Therefore, it is necessary to perform the learning necessary for the learning control.

In the technology disclosed in PCT International Publication No. WO2017/051742, a relative number of rotations of a workpiece and a relative number of vibrations of a workpiece per rotation are defined according to a vibration frequency for which an operation command can be issued by the control means of a machining device. PCT International Publication No. WO2017/051742 also describes that, as a result of this, it is possible to perform cutting of a workpiece smoothly and improve the external appearance of a machined workpiece surface. However, the range that can define the relative number of rotations and the relative number of vibrations according to the vibration frequency has a physical limit, and there is a limit for the range that defines a frequency freely.

In view of such a circumstance, upon finish, it is conventionally necessary to perform cutting not accompanied by oscillation without performing oscillation cutting. However, there are many machining programs in which ON-OFF of an oscillation function cannot be set finely by a user.

Taking account of such a situation, it is an object of the present invention to provide a numerical control device that, when performing oscillation cutting, determines a surface quality-prioritized machining part in an oscillation cutting block, stops the oscillation cutting in a case of determining as being a surface quality-prioritized machining part, and can cause a cutting device, etc., to execute cutting without oscillation.

A numerical control device according to the present invention (for example, a numerical control device 100) is a numerical control device for a cutting device, and the numerical control device includes: an oscillation component creating unit (for example, an oscillation component creating unit described later) configured to create an oscillation component command for oscillation cutting, and to command a servo motor; an oscillation component creating determination unit (for example, oscillation component creating determination unit 106 described later) configured to determine an oscillation cutting block in a machining program, and to instruct an oscillation component creating unit to perform creation of an oscillation component command; and a surface quality prioritized machining determination unit (for example, a surface quality-prioritized machining determination unit 107 described later) configured to determine a surface quality-prioritized machining part in the oscillation cutting block, in which, in a case of determining as being a surface quality-prioritized machining part, the surface quality-prioritized machining determination unit instructs the oscillation component creating determination unit to stop oscillation component creation, and the oscillation component creating determination unit that is instructed to stop the oscillation component creating instructs the oscillation component creating unit to stop creation an oscillation component command.

The surface quality-prioritized machining determination unit may determine an oscillation cutting block in a finish machining shape of a multiple fixed cycle as a surface quality-prioritized machining part.

The surface quality-prioritized machining determination unit may determine an oscillation cutting block having a smaller cut amount than a predetermined value as a surface quality-prioritized machining part.

A numerical control device according to the present invention (for example, a numerical control device 200 described later) is a numerical control device for a cutting device, the numerical control device, and the numerical control device includes: an oscillation component creating unit (for example, an oscillation component creating unit 203 described later) configured to create an oscillation component command for oscillation cutting, and to command a servo motor; and a finish machining determination unit (for example, a finish machining determination unit 206 described later) configured to determine as being a surface quality-prioritized machining part in a case in which there is a machining settings switching command in a machining program, in which, in a case of determining as being a surface quality prioritized machining part, the finish machining determination unit instructs the oscillation component creating unit to stop creation of an oscillation component command.

According to the present invention, it is possible to perform machining without oscillation on the surface quality-prioritized machining part. As a result, it is possible to improve machining quality of a machined part.

### BRIEF DESCRIPTION OF THE DRAWINGS

FIG. 1A is a block diagram illustrating the configuration of a numerical control device according to a first embodiment of the present invention;

FIG. 1B is a block diagram illustrating the configuration or conventional numerical control device;

FIG. 2A is a diagram illustrating a state of a cutting operation of the numerical control device according to the first embodiment, of the present, invention;

FIG. 2B a diagram illustrating a state of a cutting operation of a conventional numerical control device;

FIG. 3 is a flowchart illustrating a processing operation of the numerical control device according to the first embodiment of the present invention;

FIG. 4 is a flowchart illustrating a processing operation of the numerical control device according to the first embodiment of the present invention;

FIG. 5 is a flowchart illustrating a processing operation of the numerical control device according to the first embodiment of the present invention;

FIG. 6 is a block diagram illustrating the configuration of a numeral control device according to a second embodiment of the present invention; and

FIG. 7 is a diagram illustrating a state of a conventional cutting operation with oscillation.

### DETAILED DESCRIPTION OF THE INVENTION

In the following, embodiments of the present invention will be described with reference to the drawings.

### First Embodiment

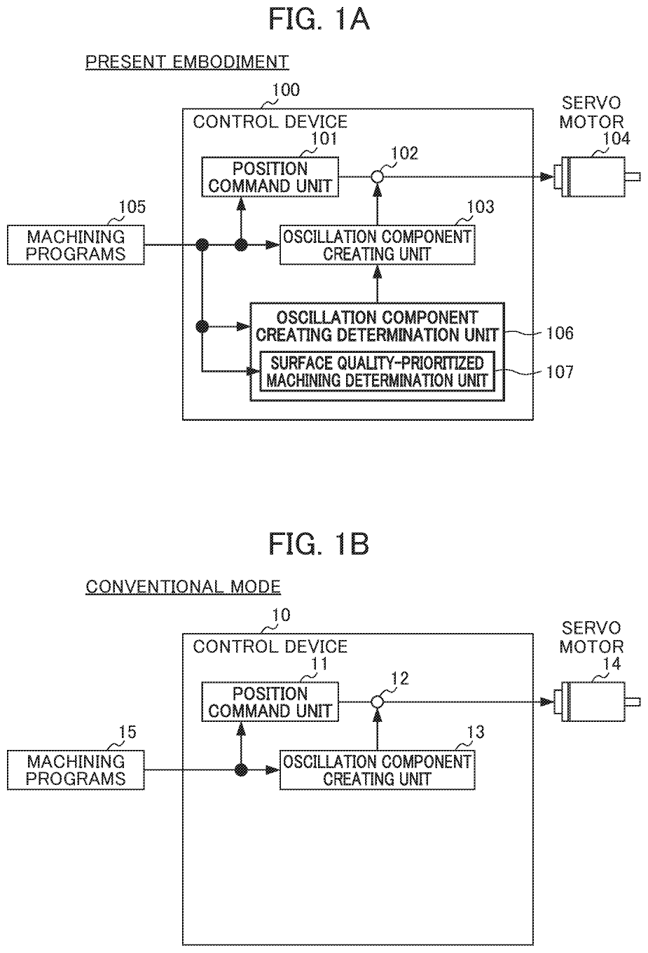

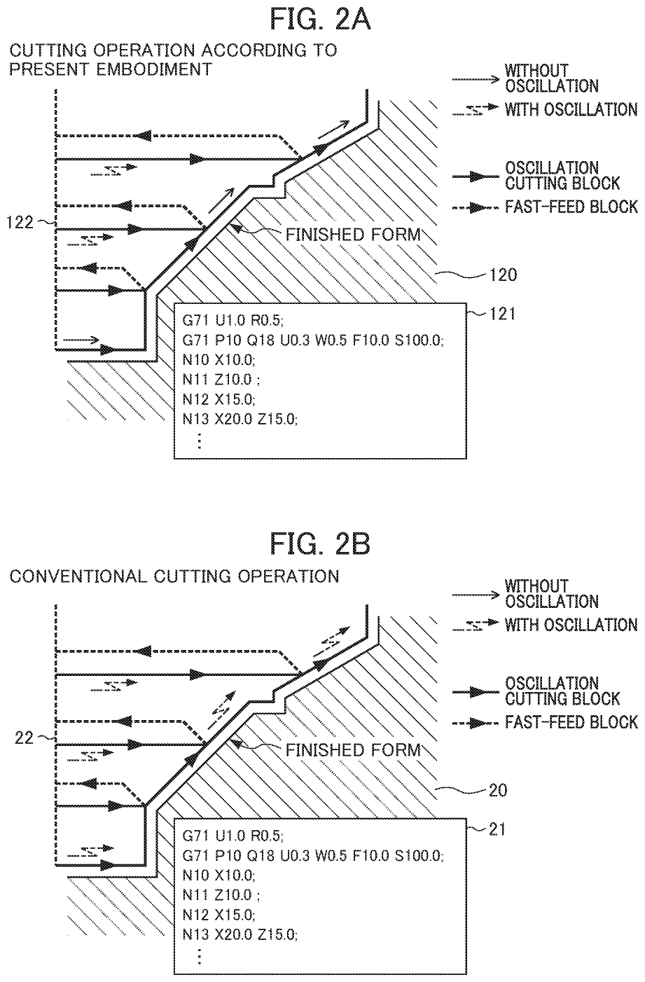

FIG. 1A is a block diagram illustrating the configuration of a numerical control device according to a first embodiment. FIG. 1B is a block diagram illustrating the configuration of a conventional numerical control device for the purpose of comparing with the configuration of FIG. 1A. FIG. 2A is a diagram illustrating a state of a cutting operation of the numerical control device according to the first embodiment. FIG. 2B is a diagram illustrating a state of a cutting operation of a conventional numerical control device for the purpose of comparing with the configuration of FIG. 2A.

### (Configuration of Numerical Control Device 100)

In the following, the configuration of the numerical control device 100 will be described. As illustrated in FIG. 1A, the numerical control device 100 creates a position command on the basis of a machining program 105, and outputs the position command to a servo motor 104 of a cutting device. It should be noted that the cutting device itself is omitted, and thus not illustrated. As illustrated in FIG. 1A, the numerical control device 100 according to the first embodiment includes a position command unit 101, an adder 102, an oscillation component creating unit 103, an oscillation component creating determination unit 106, and a surface quality-prioritized machining determination unit 107.

The position command unit 101 outputs a position command on the basis of the machining program 105. The oscillation component creating unit 103 creates an oscillation component command for oscillation cutting on the basis of the machining program 105, and commands the servo motor 104 (outputs the command). The adder 102 adds the position command that is outputted by the position command unit 101 and the oscillation component command created by the oscillation component creating unit 103, and outputs the position command including an oscillation component command. The position command supplied to the servo motor 104 is the position command including this oscillation component command. It should be noted that the machining program 105 may be supplied externally as illustrated in FIG. 1A, or alternatively, may be stored in a predetermined storage means in the interior of the numerical control device 100. Furthermore, the machining program 105 may be provided to the numerical control device 100 from a so-called cloud.

Furthermore, the position command unit 101, the adder 102, and the oscillation component creating unit 103 are conventionally used configurations. These configurations are also included in the conventional numerical control device 10 illustrated in FIG. 1B. As illustrated in FIG. 1B, the conventional numerical control device 10 has a configuration similar to these configurations (the position command unit 11, the adder 12, and the oscillation component creating unit 13), and executes the abovementioned operations. In other words, the conventional numerical control device 10 outputs the position command to which the oscillation component command is added, to the servo motor 14 on the basis of the machining program 15.

With reference to FIG. 1A again, the oscillation component creating determination unit 106 determines an oscillation cutting block in the machining program 105, and instructs the oscillation component creating unit to create the oscillation component command. The surface quality-prioritized machining determination unit 107 determines a surface quality-prioritized machining part in the oscillation cutting block. In a case in which the surface quality prioritized machining determination unit 107 has determined whether it is a surface quality-prioritized machining part and, as a result of this, it is surface quality-prioritized machining, the surface quality-prioritized machining determination unit 107 instructs the oscillation component creating determination unit 106 to perform “stopping oscillation component creating”. In a case in which the oscillation component creating determination unit 106 receives the instruction of stopping the oscillation component creating, the oscillation component creating determination unit 106 outputs “stopping creating an oscillation component command” to the oscillation component creating unit 103. In a case in which the oscillation component creating unit 103 inputs such an oscillation stop instruction, creating the oscillation component command is stopped. As a result of this, the adder 102 outputs a position command without the oscillation component command, and the position command without oscillation is supplied to the servo motor 104.

It should be noted that the above-described “stopping creating an oscillation component command” and “stopping creating an oscillation component” may be commands (instructions) on a computer as described above, or alternatively, may be signals (digital signals or analogue signals) indicative of “stopping creating an oscillation component command” or “stopping creating an oscillation component”. Furthermore, the “stopping creating an oscillation component command” as referred to herein is acceptable so long as oscillation is stopped, and thus, a state in which an oscillation component command of the oscillation amplitude of “0” is outputted is also encompassed by the “stopping creating an oscillation component command”.

The surface quality-prioritized machining determination unit 107 determines whether to establish the oscillation cutting block in the machining program as surface quality prioritized machining in this way; however, various kinds of methods may be adopted for the determination method.

### (Multiple Fixed Cycle Machining)

Multiple fixed cycle machining including a plurality of oscillation cutting blocks is useful since writing of the machining program becomes easy. For example, FIG. 2A illustrates an example of a cutting operation in a case in which the multiple fixed cycle is included in the machining program 105. FIG. 2A illustrates a cutting trajectory 122 of a cutting tool for cutting the surface of a workpiece 120 into a “finished form” (refer to FIG. 2A), and also illustrates machining programs 121 (actually, a part of the machining program 105) indicating the cutting.

The characteristic feature of the first embodiment is that, in the case of the multiple fixed cycle, oscillation is stopped since finish cutting is performed in accordance with the “finished form” (refer to FIG. 2A) given through a program at the end of the cycle. In FIG. 2A, with regard to the cutting trajectory 122, an oscillation cutting block for performing oscillation cutting (may be simply referred to as an oscillation cutting block) is denoted by a solid line, and a fast-feed block for performing fast-feed is denoted by a dash line. Furthermore, in FIG. 2A, a linear arrow indicates cutting without oscillation, and a Z-shaped arrow indicates cutting with oscillation. These illustrations are the same in FIG. 2B described later.

As illustrated in FIG. 2A, with regard to the cutting trajectory 122, the oscillation cutting is performed in a cut operation (denoted by the linear arrow), and cutting without oscillation is performed upon machining of finish processing at the end of the cycle (denoted by the Z-shaped arrow). Furthermore, the machining programs 121 uses conventional programs as they are, and the numerical control device 100 analyzes the machining programs 121, and turns off the oscillation upon the finish machining (at the end of the cycle). Therefore, according to the first embodiment, it is unnecessary to change the machining programs that are conventionally used. In the first embodiment, the multiple fixed cycle is employed. Therefore, the end of the cycle is determined as the finish processing, and thus, the processing illustrated in FIG. 2A is executed. However, as long as it can be determined as the finish processing, it is possible to turn off the oscillation in other cases as well.

(Comparison with Conventional Operation)

FIG. 2B illustrates the conventional operation, while FIG. 2A illustrates the operation according to the first embodiment. In other words, FIG. 2B illustrates an example of the conventional cutting operation in a case in which the multiple fixed cycle is included in the machining program 15. FIG. 2B also illustrates a cutting trajectory 22 of a cutting tool for cutting a surface of the workpiece 20 into the “finished form”, and also illustrates a machining program 21 (actually, a part, of the machining program 15) indicating the cutting. As illustrated in FIG. 2B, conventionally, in the case of the multiple fixed cycle, when the oscillation cutting block is being executed, the oscillation (the cutting with oscillation) is executed at the end of the cycle. This also applies to the finish cutting in accordance with the “finished form” illustrated in FIG. 2B (refer to FIG. 2B). Therefore, in the case of the conventional operation (in the case of FIG. 2B), a case is assumed in which it is difficult to maintain high surface quality of the workpiece 20. On the contrary, according to the first embodiment, since it is determined that the finish cutting is performed at the end of the cycle of the multiple fixed cycle machining, and the cutting without oscillation is performed (FIG. 2A), it is possible to maintain the surface of the workpiece 120 at high quality as compared with surfaces made with conventional methods.

### (Machining Program)

It should be noted that, in the case of the multiple fixed cycle machining, since each block is configured as a set, it is difficult to add a G-code to turn on and off the oscillation in the middle of the machining, for example. In the example of FIG. 2A, the G-code “G71” indicates the multiple fixed cycle machining. However, it is set so that the G-code that turns on the oscillation component command is added at a preceding stage of the machining program 121. This also applies to the conventional example of FIG. 2B. Furthermore, “P10, Q18” in the second line of the machining program 121 indicates the blocks 10 to 18 for processing, and “U0.3, W0.5” in the second line indicates the cut amount (X direction, Z direction). In FIG. 2A, it is determined as the multiple fixed cycle machining based on the G-code (for example, G71); however, the determination may be made based on another G-code depending on the type of the numerical control device 100.

### (Details of Processing Operation)

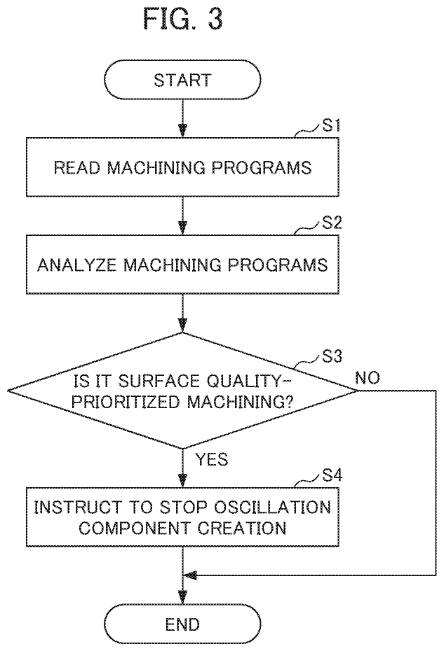

A characteristic processing operation of the numerical control device 100 according to the first embodiment will be described on the basis of a flowchart. FIG. 3 illustrates a flowchart showing processing operations of the numeral control device 100 according to the first embodiment. The processing operations shown in this flowchart are operations by the oscillation component creating determination unit 106 and the surface quality-prioritized machining determination unit 107. Processing operations of configurations which are similar to conventional such as those of the position command unit 101 are similar to conventional operations, and will not be described in detail. First, in Step S1, the surface quality-prioritized machining determination unit 107 of the oscillation component creating determination unit 106 of the numerical control device 100 reads the machining programs 105 from a predetermined storage unit. The machining programs 105 may be stored anywhere. The machining programs 105 may be stored in a cloud, or alternatively, may be stored in the numerical control device 100. In Step S2, the surface quality-prioritized machining determination unit 107 analyzes the machining programs 105, and determines the surface quality-prioritized machining part in the oscillation cutting block of the machining programs 105.

In Step S3, the surface quality-prioritized machining determination unit 107 determines whether it is surface quality-prioritized machining on the basis of a result of the analysis in Step S2. In a case in which it is the surface quality-prioritized machining, the processing advances to Step S4, and in a case in which it is not the surface quality-prioritized machining, the processing ends. In Step S4, the surface quality-prioritized machining determination unit 107 instructs the oscillation component creating determination unit 106 to stop the oscillation component creating. Thereafter, the oscillation component creating determination unit 106 instructs the oscillation component creating unit 103 to stop the oscillation component command creating. With such processing, as described in FIG. 2A, in a case in which it is the surface quality-prioritized machine, it is possible to realize performing the cutting without oscillation, and thus, it is possible to improve the quality of the surface of the workpiece 120.

### (Determination of Whether Surface Quality-Prioritized Machining)

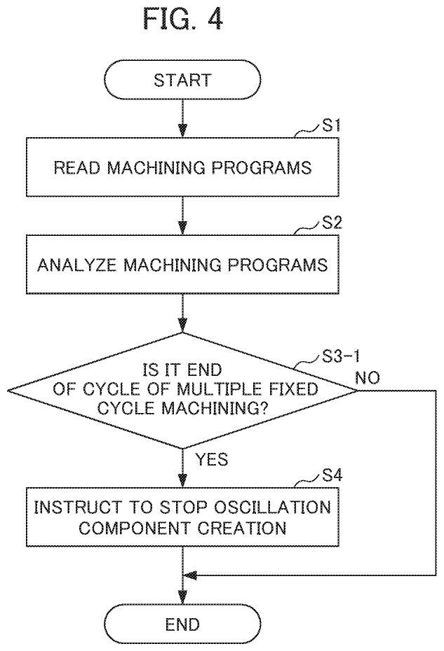

With regard to the determination as to whether it is the surface quality-prioritized machining, various kinds of methods may be adopted through the machining program 105 to be used. For example, in the first embodiment, FIG. 2A describes the example in which the G-code in the machining program 105 is read and the determination is made as to whether it is the multiple fixed cycle machining. The processing operation of the numerical control device 100 in this case is shown in the flowchart of FIG. 4.

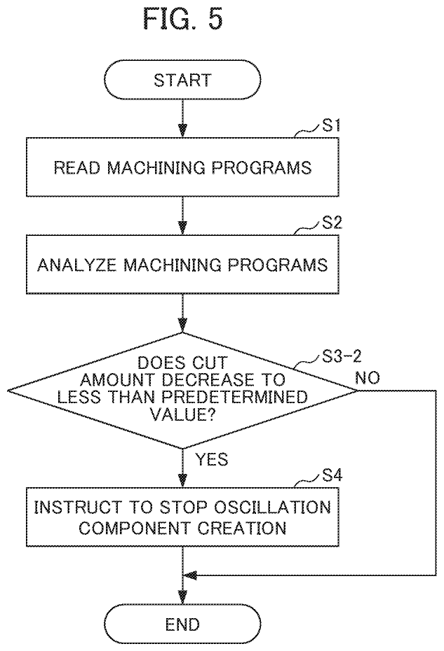

In FIG. 4, Steps S1, S2, and S4 are the same as those in FIG. 3 in terms of the processing. In Step S3-1, whether it is the end of a cycle of the multiple fixed cycle machining is determined. As a result of the determination, if it is the end of the cycle of the multiple fixed cycle machining, the processing advances to Step S4 to stop the oscillation, and if it is not the end of the cycle of the multiple fixed cycle machining, the processing ends. With such a method, it is possible to determine whether it is the surface quality-prioritized machining part. This determination processing may be executed by the surface quality prioritized machining determination unit 107. Furthermore, for example, a determination can be made on the basis of whether a cut amount decreased to be less than a predetermined value. The processing operation of the numerical control device 100 of this case is shown in the flowchart of FIG. 5.

In FIG. 5, Steps S1, S2, and S4 are the same as those in FIG. 3 in terms of the processing. In Step S3-2, the cut amount of the cutting is successively monitored, and in a case in which the amount decreased to be less than a predetermined amount (in a case of a thin cut), it is determined as the surface quality-prioritized machining part such as the finish processing. This determination may be executed by the surface quality-prioritized machining determination unit 107. The decrease in the cut amount can be grasped by inspecting the position of the position command to the servo motor 104, and setting the difference of the position as a cut amount for each cut. For a predetermined reference value, a reasonable value may be set appropriately by the machining programs 105 depending on a required surface quality. It should be noted that the cut amount may be calculated for each oscillation cutting block in the machining programs 105. As a result thereof, the surface quality-prioritized machining determination unit 107 can determine the oscillation cutting block having a cut amount smaller than a predetermined value as the surface quality-prioritized machining part.

### Second Embodiment

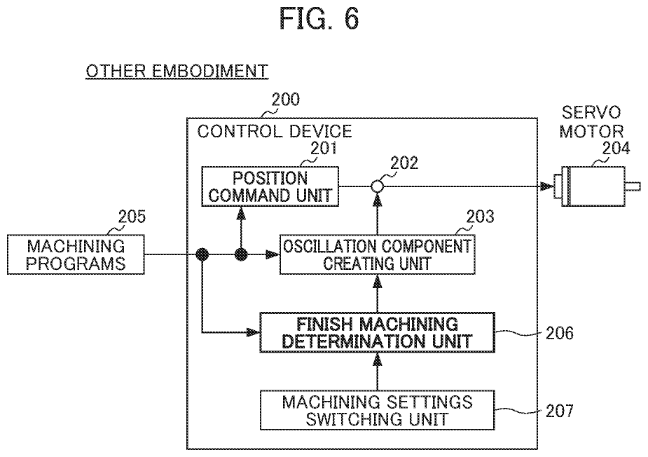

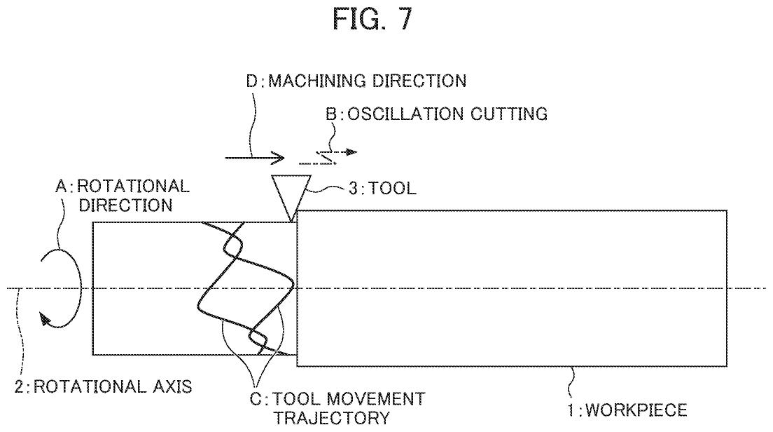

FIG. 6 illustrates a configuration diagram of a numerical control device 200 according to a second embodiment (other embodiment). In the first embodiment, an example of the numerical control device 100 is described in which it is determined whether it is the surface quality-prioritized machining and the oscillation can be stopped on the basis of the determination result. Specifically, the case in which it is determined whether it is the multiple fixed cycle and the case in which the cut amount decreases are described above. However, another method may be adopted to determine whether it is the surface quality-prioritized machining. For example, the numerical control device 200 may have a function of switching a machining setting, and enable switching among “accuracy-prioritized”, “finish”, “semi-finish”, and the like illustrates an example of a configuration diagram of the numerical control device 200 in the case of having such a function.

The numerical control device 200 includes a position command unit 201, an adder 202, an oscillation component creating unit 203, a finish machining determination unit 206, and a machining settings switching unit 207. Since the position command unit 201, the adder 202, the oscillation component creating unit 203 have the same configuration as the position command unit 101, the adder 102, and the oscillation component creating unit 103, the descriptions thereof will be omitted.

The finish machining determination unit 206 analyzes the machining programs 205, and determines whether it is accuracy-prioritized machining, finish machining, or semi-finish machining. Thereafter, in a case of being the “accuracy-prioritized” and the “finish” on the basis of the determination result, the oscillation stop instruction is outputted to the oscillation component creating unit 203. In a case of inputting the oscillation stop instruction, the oscillation component creating unit 203 stops outputting the oscillation component command, or causes to perform cutting without oscillation by setting a value of the oscillation component command as “0”. Furthermore, in a case of being the “semi-finish” as a result of the analysis, the finish machining determination unit 206 outputs an oscillation decrease instruction to the oscillation component creating unit 203 in order to decrease the oscillation amount. In a case of inputting the oscillation decrease instruction, the oscillation component creating unit 203 sets the value of the oscillation component command to a smaller value, and causes to perform cutting with a decreased oscillation amount.

In this way, similarly to the oscillation component creating determination unit. 106 and the surface quality-prioritized machining determination unit 107 of the first embodiment, the finish machining determination unit 206 analyzes the machining program 205. As a result, it is possible to adjust the oscillation amount depending on the degree of prioritization of the surface quality. Similarly to the first embodiment, it is possible to stop the oscillation completely, or alternatively, decrease the oscillation approximately by half. In this way, according to the second embodiment, it is possible to “select, from a plurality of patterns, a setting value of a parameter group relating to machining accuracy and product quality, and perform switching”. The oscillation amount and the oscillation pattern may be switched depending on each pattern. Furthermore, this switching can be performed by using the G-code in the machining program 205. The G-code for such a switching corresponds to a preferred example of a machining settings switch command of the claims.

As described above, in a case in which there is a G-code (the machining settings switch command) for switching in the machining program, the finish machining determination unit 206 determines that it is a surface quality-prioritized machining part. In a case in which the finish machining determination unit 206 detects the G-code that has been detected, the finish machining determination unit 206 can instruct the oscillation component creating unit 203 to stop the oscillation, etc., depending on the pattern that is switched by the G-code.

Furthermore, the numerical control device 200 according to the second embodiment can include the machining settings switching unit 207. The machining settings switching unit provides the above-described “setting value of a parameter group relating to machining accuracy and product quality” according to a user's operation or a signal from an external another control device. As a result, the finish machining determination unit 206 that receives these setting values can cause to execute “selecting, from a plurality of patterns, a setting value of a parameter group relating to machining accuracy and product quality, and performing switching” described above on the basis of these setting values. For example, the machining settings switching unit 207 includes a predetermined button, and in a case in which a user presses the button, it is possible to turn off the oscillation. The machining settings switching unit 207 may be configured to include a plurality of buttons so that the user can select from a plurality of patterns.

### (Effects of the Embodiments)

As described above, according to the first embodiment and the second embodiment, it is possible to determine whether it is a surface quality-prioritized machining part, and adjust the oscillation on the basis of the determination result (for example, turn on and off). As a result, it is possible to further improve the quality of a machined surface of a workpiece.

### Other Embodiments

Although embodiments of the present invention have been described above, the present invention is not limited to the above-described embodiments. Furthermore, the effects described in the present embodiments are merely listing the most preferred effects produced from the present invention, and the effects produced from the present invention are not limited to the effects described in the present embodiments.

### Modification Example 1

In the first embodiment, a configuration is described in which the surface quality-prioritized machining determination unit 107 is included in the oscillation component creating determination unit 106; however, the surface quality-prioritized machining determination unit 107 may be configured to be separated and independent from the oscillation component creating determination unit 106. Furthermore, the surface quality-prioritized machining determination unit 107 and the oscillation component creating determination unit 106 may not be present in the interior of a housing of the numerical control device 100, and may rather be configured as an external auxiliary device, an externally connected computer, or another device that is connected via a network.

### Modification Example 2

In the second embodiment, the finish machining determination unit 206 and the machining settings switching unit 207 may not be present in the interior of the numerical control device 200, and may rather be configured as an external auxiliary device, an externally connected computer, or another device that is connected via a network.

### Modification Example 3

The numerical control device 100 according to the first embodiment and the numerical control device 200 according to the second embodiment may each be configured as a computer system including a CPU. In such a case, the CPU reads the programs stored in a storage unit such as ROM and, according to the programs, causes to execute a computer as the position command units 101 and 201, the adders 102 and 202, the oscillation component creating units 103 and 203, the oscillation component creating determination unit 106, the surface quality-prioritized machining determination unit 107, the finish machining determination unit 206, and the machining settings switching unit 207.

### Modification Example 4

In the first and second embodiments, examples of the numerical control devices 100 and 200 that numerically control a machine tool have been described. However, as long as similar processing is executed, the machine tool itself may realize a similar processing operation. Furthermore, a management computer that manages a factory overall may collectively realize a similar processing operation.

### EXPLANATION OF REFERENCE NUMERALS

1 workpiece
2 rotational axis
3 tool
10, 100, 200 numeral control device
11, 101, 201 position command unit
12, 102, 202 adder
13, 103, 203 oscillation component creating unit
14, 104, 204 servo motor
15, 105, 205 machining program
20, 120 workpiece
21, 121 machining program
22, 122 cutting trajectory
106 oscillation component creating determination unit
107 surface quality-prioritized machining determination unit
206 finish machining determination unit
207 machining settings switching unit
A rotational direction
B oscillation cutting
C tool movement trajectory
D machining direction

What is claimed is:

1. A numerical control device for a cutting device, the numerical control device comprising:
an oscillation component creating unit configured to create an oscillation component command for oscillation cutting, and to command a servo motor;
an oscillation component creating determination unit configured to determine an oscillation cutting block in a machining program, and to instruct an oscillation component creating unit to perform creation of an oscillation component command; and
a surface quality-prioritized machining determination unit configured to determine a surface quality-prioritized machining part in the oscillation cutting block,
wherein, in a case of determining as being a surface quality-prioritized machining part, the surface quality-prioritized machining determination unit instructs the oscillation component creating determination unit to stop oscillation component creation, and
the oscillation component creating determination unit that is instructed to stop the oscillation component creating instructs the oscillation component creating unit to stop creation an oscillation component command.

2. The numerical control device according to claim 1, wherein the surface quality-prioritized machining determination unit determines an oscillation cutting block in a finish machining shape of a multiple fixed cycle as a surface quality-prioritized machining part.

3. The numeral control device according to claim 1, wherein the surface quality prioritized machining determination unit determines an oscillation cutting block having a smaller cut amount than a predetermined value as a surface quality-prioritized machining part.

4. A numerical control device for a cutting device, the numerical control device comprising:
an oscillation component creating unit configured to create an oscillation component command for oscillation cutting, and to command a servo motor; and
a finish machining determination unit configured to determine as being a surface quality-prioritized machining part in a case in which there is a machining settings switching command in a machining program,
wherein, in a case of determining as being a surface quality-prioritized machining part, the finish machining determination unit instructs the oscillation component creating unit to stop creation of an oscillation component command.
